(19) United States
(12) Patent Application Publication
(10) Pub. No.: US 2012/0212954 A1
(43) Pub. Date: Aug. 23, 2012

(54) ILLUMINATION DEVICE

(75) Inventors: Hidenori Hirai, Ibara-shi (JP); Noboru Kataoka, Ibara-shi (JP); Hidemasa Ohta, Ibara-shi (JP)

(73) Assignee: KATAYAMA KOGYO CO., LTD., Ibara-shi, Okayama (JP)

(21) Appl. No.: 13/505,044

(22) PCT Filed: Oct. 12, 2010
(86) PCT No.: PCT/JP2010/006052

§ 371 Date: Apr. 30, 2012

(30) Foreign Application Priority Data
Nov. 9, 2009 (JP) 2009-255969

(51) Int. Cl. F21S 4/00

(52) U.S. Cl. 362/223

(57) ABSTRACT

Provided is an illumination device capable of providing uniform illumination along a specific direction. The illumination device is provided with a shaped member which extends in a specific direction, which has an opening section that opens towards a front side in a front/rear direction perpendicular to the specific direction, and which has a curved shape that protrudes towards a rear side; a base member which has translucent properties and is accommodated inside the shaped member while being exposed to the outer side of the shaped member via the opening section of the shaped member; a covering member which has light blocking properties and covers at least a portion of a front side portion of the base member from the front; and light emission means. The light emission means are fixed inside a recess section of the base member so as to be separated from each other in the specific direction.

### TECHNICAL FIELD

The present invention relates to an illumination device having a function of illuminating an object along a specific direction.

### BACKGROUND ART

In an object, such as a handrail, which extends in a specific direction and is provided in an entrance or a corridor of a building, or the like, there is a demand for the object, such as a handrail, to be illuminated in the lengthwise direction thereof. For example, Japanese Patent Application Publication No. H11-117483 discloses a device in which an optical fiber extending in a specific direction is provided in a hollow portion of a handrail, and a light source is provided at one end of the optical fiber. In this device, light from the light source is transmitted along the optical fiber and irradiated externally via opening holes formed in the handrail.

### SUMMARY OF THE INVENTION

In a device using the optical fiber described above, the quantity of light propagated along the optical fiber is attenuated as the distance from the light source increases, and therefore uniform illumination along the specific direction is difficult to achieve.

The object of the present invention is to provide an illumination device which is capable of illuminating an object uniformly along a specific direction.

In order to achieve this object, the illumination device according to the present invention comprises: a shaped member which extends in a specific direction, which has an opening section that opens towards a front side in a front/rear direction perpendicular to the specific direction, and which has a curved shape that protrudes towards a rear side; a base member which has translucent properties and extends in the specific direction, at least a portion of the base member being accommodated inside the shaped member in a state where a front side portion of the base member is exposed to the outer side of the shaped member via the opening section of the shaped member; a covering member which has light blocking properties, extends in the specific direction and is provided on the front side portion of the base member in a state of covering at least a portion of the front side portion of the base member from the front; and a plurality of light emission members capable of emitting light, wherein the base member has a rear end surface which extends in the specific direction and also has a recess section which is recessed to the front side from the rear end surface, and the light emission members are fixed to an inner side of the recess section so as to be separated from each other in the specific direction.

According to this device, the peripheral area of the illumination device is illuminated in substantially uniform fashion in the specific direction.

### BRIEF DESCRIPTION OF THE DRAWINGS

FIG. 1 is a schematic drawing showing a handrail to which the illumination device relating to the present invention is applied.

FIG. 2 is a diagram showing a state where a user is gripping the handrail shown in FIG. 1.

FIG. 3 is a lateral cross-sectional view of an illumination device relating to one embodiment of the present invention.

FIG. 4 is a lateral cross-sectional view of an illumination device relating to a further embodiment of the present invention.

FIG. 5 is a cross-sectional diagram along V-V in FIG. 4.

### BEST MODE FOR CARRYING OUT THE INVENTION

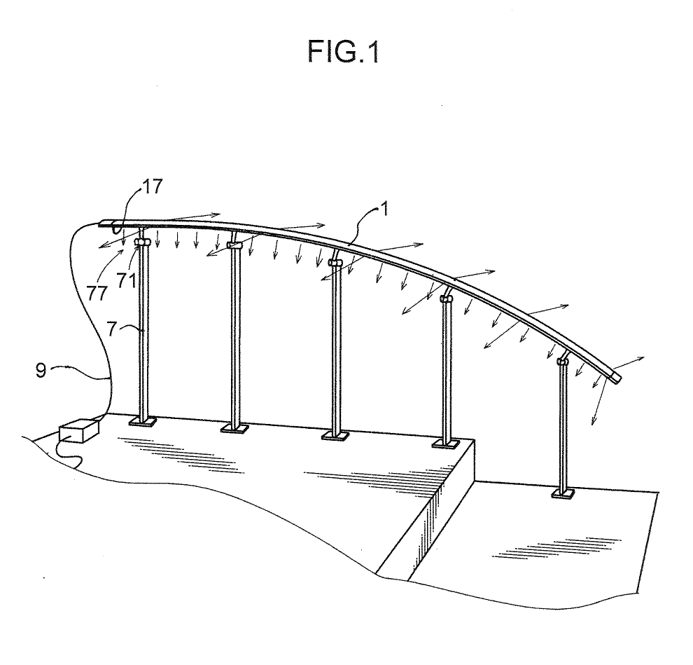

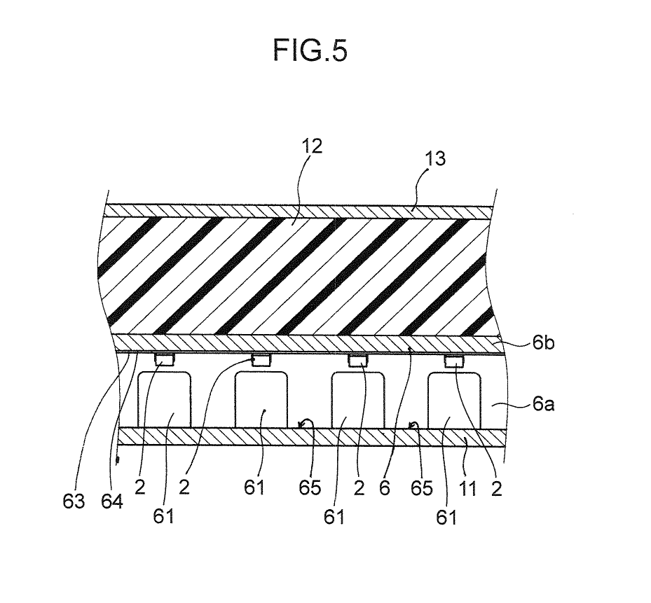

An embodiment of the present invention is described now with reference to FIG. 1 to FIG. 5.

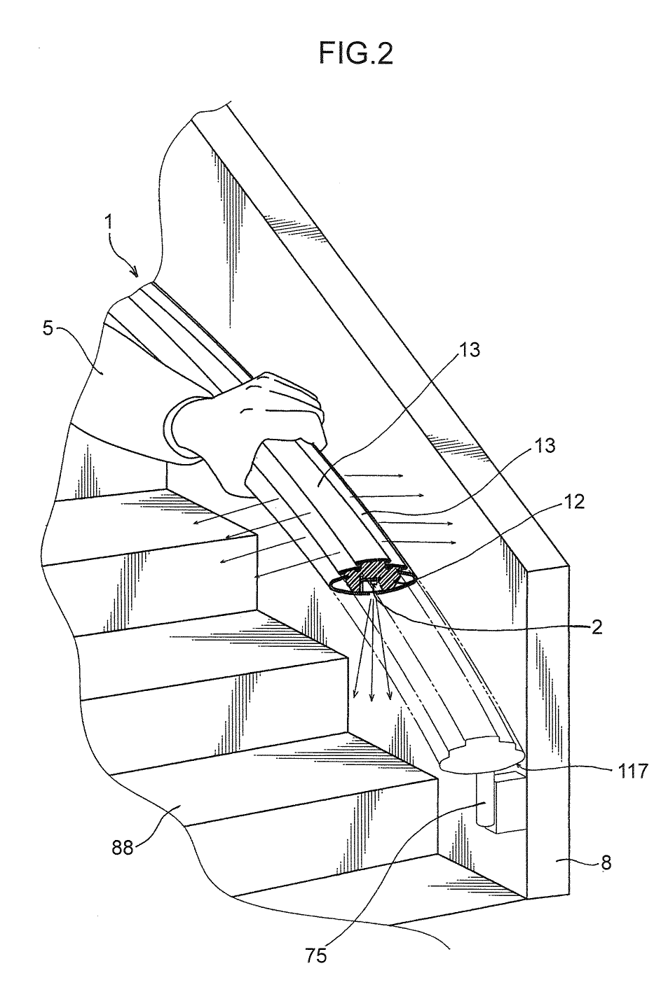

The illumination device relating to the present invention is used as a handrail main body 1 having an illuminating function, as shown in FIG. 1 and FIG. 2, for example.

In FIG. 1, the handrail main body 1 is provided in one portion of an entrance, for example, and illuminates the periphery of steps 88 which form the entrance. The handrail main body 1 has an arch shape overall. The handrail main body 1 is supported by a plurality of supporting bars 7. The plurality of supporting bars 7 are arranged at prescribed intervals apart in the lengthwise direction of the handrail main body 1. The front end portion (upper end portion) 71 of each of these supporting bars 7 and a lower surface section of the handrail main body 1 are connected together by a connecting device 77.

In FIG. 2, the handrail main body 1 is provided on a side wall 8 of the steps 88. This handrail main body 1 is installed on a side wall 8 of the steps 88 via an installation device 75 which is provided on the lower surface section of the handrail main body 1.

As shown in FIG. 2, a pedestrian 5, or the like, is able to go up and down the steps 88 while maintaining his or her own stability by gripping the handrail main body 1 with his or her hand.

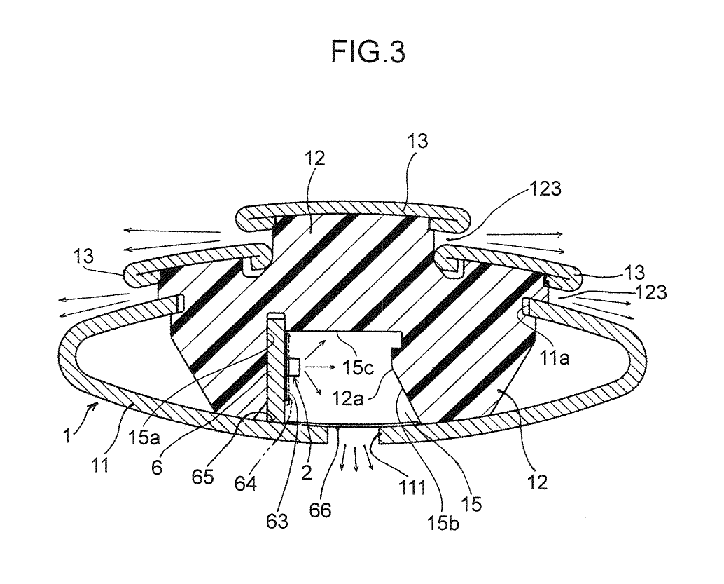

A concrete composition relating to a first embodiment of the handrail main body 1 will be described now with reference to FIG. 3.

The handrail main body 1 has a shaped member 11, a base member 12, a plurality of strip-shaped members (covering members) 13 and a plurality of LEDs (light emission members) 2.

The shaped member 11 is a plate-shaped member extending in a specific direction. A lateral cross-section of the shaped member 11, in other words, a cross-section in a direction perpendicular to the specific direction, which is the lengthwise direction of the shaped member 11, shows a curved shape which is open on a front side and protrudes outwards on a rear side, in other words, a C shape. An opening section 11a which extends in the lengthwise direction of the shaped member 11 and opens towards the front side is formed in a front surface of the shaped member 11.

This shaped member 11 is formed, for example, by molding a long member made of stainless steel using roll forming means.

A plurality of opening holes 111 are formed in the rear surface of the shaped member 11, at substantially uniform intervals in the lengthwise direction of the shaped member 11. These opening holes 111 are each closed off by a film-shaped protective member 66 which has translucent properties.

As described below, the protective member 66 serves to protect the LEDs 2 while transmitting the light from the LEDs 2 to the exterior of the shaped member 11.

The base member 12 is a rod-shaped member which extends in a prescribed direction, and has translucent properties (light propagating properties and light diffusing properties). This base member 12 is, for example, made of plastic which is semi-translucent and has light diffusing properties. This base member 12 is formed by extrusion molding means or injection molding means, for instance. Here, if the illumination device is used as handrail main body 1, as in the present embodiment, then desirably the base member 12 is formed from a soft plastic material having low hardness. If the base member 12 is formed from a soft plastic material in this way, then the whole of the base member 12 bends flexibly and therefore the pedestrian, or the like, experiences a soft feeling in the hand which grips the base member 12, and the handrail main body 1 becomes more convenient for the pedestrian to grip and hold, in addition to which the bending process, and the like, is made easier.

This base member 12 is fixed to an inner side of the shaped member 11 in a state of extending in the lengthwise direction of the shaped member 11. In the present embodiment, the base member 12 is fixed to the shaped member 11 by fitting the shaped member 11 into groove sections formed in a central portion in the front/rear direction of the base member 12, the rear side section of the base member 12 being accommodated inside the shaped member 11, while the front side portion of the base member 12 projects to the front side of the shaped member 11 through the opening section of the shaped member 11. In other words, the front side portion of the base member 12 is exposed on the outside of the shaped member 11 through the opening section in the shaped member 11.

A recess section 12a which is recessed from a rear surface towards the front side is formed in the base member 12. This recess section 12a extends in the lengthwise direction of the base member 12. A lateral cross-section of this recess section 12a is a substantially quadrilateral shape, and hence a cavity section 15 forming a substantially parallelepiped-shaped space is formed extending in the lengthwise direction of the base member 12 on the inner side of the recess section. An inner surface of the recess section 12a which surrounds the cavity section 15 comprises vertical wall sections 15a, 15b which are mutually opposing and extend the front/rear direction, and a horizontal section (lateral wall section) 15c which extends between the vertical wall sections 15a and 15b. In this way, in the present embodiment, the lateral cross-section of the base member 12 is shaped like a doorway with an opening on the rear side. The recess section 12a surrounds the perimeter of the opening hole 111 of the shaped member 11 as viewed from the rear side, and the opening hole 111 and the cavity section 15 are connected via the protective member 66.

The front side portion of the base member 12 is constituted by a plurality of parts in the left/right direction (the direction perpendicular to the specific direction and the front/rear direction), each part projecting forward by a different amount from the front end portion of the shaped member 11. In the present embodiment, the central part of the base member 12, in the left/right direction, projects furthest forward, and the parts on the left and right-hand side of this central part are positioned to the rear of the central part. The front end surfaces of these respective parts constitute a surface which is substantially perpendicular to the front/rear direction.

The plurality of strip-shaped members 13 serve to cover, from the front, at least one portion of the front side portion of the base member 12 which is exposed to the outside of the shaped member 11. These strip-shaped members 13 are plate-shaped members which respectively extend in a prescribed direction and are fixed to the front end surface of the base member 12 along the lengthwise direction of the base member 12. These strip-shaped members 13 are opaque and have light blocking properties. In the present embodiment, these strip-shaped members 13 are made of metal, such as stainless steel. The strip-shaped members 13 are fixed to the front end surfaces of the base member 12 by adhesive, for instance, and are oriented so as to follow the front end surfaces. As described above, the front end surfaces of each part of the front side portion of the spacer member 12 are surfaces which are substantially perpendicular to the front/rear direction, and the strip-shaped members 13 also extend substantially in mutually parallel fashion in a plane which is substantially perpendicular to the front/rear direction.

In the present embodiment, three strip-shaped members 13 are provided, one of these being fixed to the front end surface of a central portion, in the left/right direction, of the front side portion of the base member 12, and the remaining two being fixed to the front end surfaces of the left and right side portions of base member 12, in such a manner that the strip-shaped members are arranged in left/right symmetry overall. The width in the left/right direction of each strip-shaped member 13 is respectively larger than the width in the left/right direction of the front end surface of each portion of the base member 12, and hence the whole of the front side portion of the base member 12 is covered from the front by these strip-shaped members 13. In this way, the shaped member 11 and the strip-shaped members 13 cover the base member 12 and constitute the outer shape of the handrail main body 1. Here, the shaped member 11 has a C-shaped cross-section and the strip-shaped members 13 extend in a substantially perpendicular direction to the front/rear direction, to the front side of the opening section of the shaped member 11, and therefore the overall outer shape of the handrail main body 1 constituted by these strip-shaped members 13 and the shaped member 11 is a substantially elliptical cross-sectional shape. In particular, in the present embodiment, the strip-shaped members 13 on the left and right-hand sides are disposed to the rear of the central member in the left/right direction, and hence the outer shape of the handrail main body 1 is a shape which approximates an elliptical shape.

On the other hand, the strip-shaped member 13 which is provided centrally in the left/right direction and the strip-shaped members 13 provided on the left and right-hand sides are mutually separated in the front/rear direction. Therefore, gaps 123 are formed in the front/rear direction between the mutually adjacent strip-shaped members 13.

Furthermore, the strip-shaped members 13 provided on the left and right-hand sides are arranged at positions which are separated towards the front side from the shaped member 11, and hence gaps 123 are formed in the front/rear direction between the strip-shaped members 13 and the molding direction 11. The base member 12 is exposed to the exterior in the left/right direction via these gaps 123.

The plurality of LEDs 2 serve to illuminate the peripheral area of the handrail main body 1. This plurality of LEDs 2 are arranged inside the cavity section 15 of the base member 12, at positions that are mutually separated in the lengthwise direction of the base member 12.

In the present embodiment, an installation member 6 which extends in the lengthwise direction of the base member 12 is provided on the surface of one vertical wall section 15a which extends in the front/rear direction, of the inner surfaces of the recess section 12a. A flexible substrate 63 is fixed to the surface of this installation member 6. The LEDs 2 are fixed to the substrate 63 in a row following the lengthwise direction of the base member 12. The LEDs 2 are fixed to the surface of the substrate 63 by double-sided adhesive tape, for instance. A reflector plate 64 having a reflecting function is provided about the periphery of the LEDs 2 on the surface of the substrate 63.

A portion of the light emitted from the LEDs is incident on the base member 12 and propagates through the base member 12. In the present embodiment, the installation member 6 is made of aluminum and has light blocking properties, as described below, and therefore the light of the LEDs 2 is incident on the vertical wall section 15b opposing the vertical wall section 15a where the LEDs 2 and the installation member 6 are installed, of the vertical wall sections 15a, 15b of the recess section 12a, and on the horizontal section 15c of the recess section 12a. The shaped member 11 which surrounds the base section 12, and the strip-shaped members 13, each have light-shielding properties. Therefore, the light which propagates through the base section 12 is irradiated externally only from the portions at the gaps 123 between the shaped member 11 and the strip-shaped members 13, thereby illuminating the handrail main body 1. As described above, the gaps 123 are open in the left/right direction and the light from the LEDs 2 is irradiated only in the leftward and rightward directions and is not irradiated towards the front side.

Furthermore, the light emitted from the LEDs 2, including the light reflected by the reflector plate 64, is randomly reflected by the inner surfaces of the recess section 12a and is then transmitted through the protective member 66 and irradiated towards the rear side of the handrail main body 1 from the opening hole 111 in the shaped member 11.

The LEDs 2 are arranged along the lengthwise direction of the base member 12, and the gaps 123 extend in the lengthwise direction. Consequently, the handrail main body 1 is uniformly illuminated along the lengthwise direction of the base member 12 and the shaped member 11, in other words, the specific direction, by light emitted from the LEDs 2. Furthermore, light is irradiated below the handrail main body 1, in a uniform fashion along the lengthwise direction of the base member 12.

The installation member 6 serves to radiate heat which is generated as a result of light emission from the LEDs 2. This installation member 6 is a plate-shaped member having a heat transmitting function and a heat radiating function. The installation member 6 is made of aluminum, for example. The lower end portion 65 of the installation member 6 is fixed inside the cavity section 15 of the base member 12, in a state of contact with a portion of the shaped member 11.

The heat generated by the LEDs 2 is transmitted to the installation member 6 and dispersed to the periphery. Consequently, build up of heat in the area of the LEDs 2 and overheating of the handrail main body 1 is suppressed. This ensures the safety of the pedestrian, or the like, who is holding the handrail main body 1. In particular, in the present embodiment, the installation member 6 contacts the shaped member 11 and heat emitted from the LEDs 2 is transmitted from the installation member 6 to the shaped member 11 and is dispersed efficiently from same to the peripheral area of the handrail main body 1.

The handrail main body 1 which is composed as described above is fixed to a side wall 8 of the steps 88, or the like, with the opening section of the shaped member 11 facing upwards, for example. In this fixed state, since the handrail main body 1 has a substantially elliptical shape with a long dimension arranged in the horizontal direction, then the pedestrian, or the like, is able to grip the handrail main body 1 readily. This ensures the safety of the pedestrian, or the like.

The gaps 123 open in the horizontal direction and light emitted from the LEDs 2 which has propagated through the base member 12 is irradiated only in the horizontal direction and is not irradiated upwards. Therefore, the handrail main body 1 is illuminated without light shining directly into the pedestrian's eyes. Furthermore, when fixed in this state, the opening hole 111 of the shaped member 11 faces downwards and the light emitted from the LEDs 2 which is irradiated from the opening hole 111 shines below the handrail main body 1 and illuminates the stepping positions of a pedestrian, or other person, who is using the steps 88, or the like. This ensures the safety of the pedestrian, or the like. In this way, the handrail main body 1 ensures the safety of the pedestrian, or the like, by emitting light horizontally and downwards in a uniform fashion along the lengthwise direction, as well as functioning as display means for emitting a pale light overall, without shining light directly into the pedestrian's eyes, and thus transmitting a relaxed feeling to the pedestrian.

In particular, as shown in FIG. 1, if the shaped member 11, the strip-shaped members 13 and the base member 12 are formed with a curved shape in the front/rear direction, in other words the up/down direction, through the lengthwise direction of each, then the handrail main body 1 forms a handrail which emits light uniformly along a curved line, thus creating an appearance which is pleasing to the pedestrian.

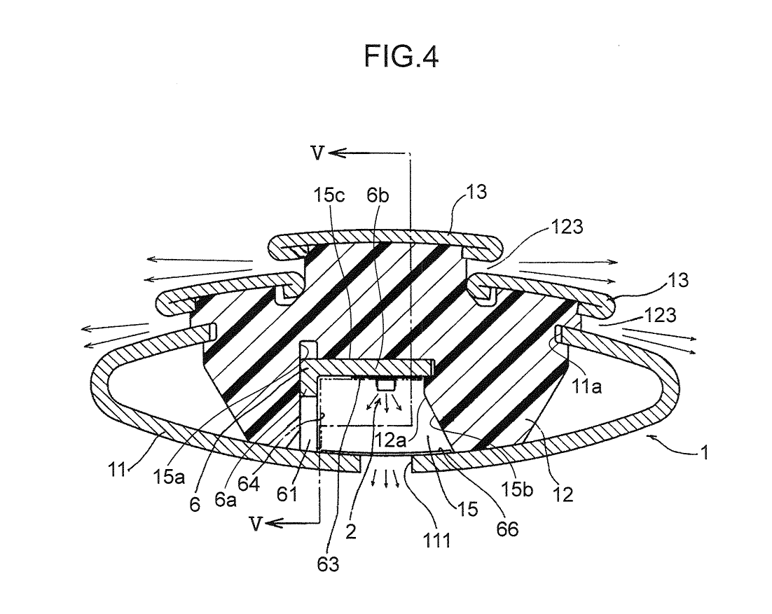

A concrete composition relating to a second embodiment of the handrail main body 1 will be described now with reference to FIG. 4.

The handrail main body 1 relating to this second embodiment differs from the first embodiment in terms of the shape of the installation member 6 and the position of the LEDs 2. Here, only the shape of the installation member 6 and the installation position of the LEDs 2 will be described.

The installation member 6 is a plate-shaped member which has an L-shaped cross-section and extends in the lengthwise direction of the base member 12. The installation member 6 comprises a vertical wall 6a extending in the front/rear direction and a front wall 6b extending so as to project in the left/right direction from the front end of the vertical wall 6a. The vertical wall 6a of this installation member 6 extends along one vertical wall section 15a of the recess section 12a, and the front wall 6b of the installation member 6 is fixed to the recess section 12a in a state extending along the horizontal section 15c of the recess section 12a. A plurality of opening apertures 61 passing through from the front to rear surface are formed in the vertical wall 6a of the installation member 6, along the lengthwise direction of the base member 12. In the present embodiment, the opening apertures 61 are formed at equidistant intervals apart in the lengthwise direction of the base member 12. The lower end part of each portion of the vertical wall 6a of the installation member 6 which surrounds an opening aperture 61 contacts the shaped member 11 and hence the heat emitted from the LEDs 2 is transmitted to the shaped member 11 from the installation member 6.

The LEDs 2 are fixed on the front wall 6b of the installation member 6, in one row along the lengthwise direction of the base member 12, in an attitude of irradiating light towards the rear side, via the substrate 3. The LEDs 2 are arranged at positions opposing the opening apertures 111 of the shaped member 11, and irradiate light towards the opening apertures 111. Furthermore, a reflector plate 64 is fixed to the front wall 6b of the installation member 6.

In the handrail main body 1 relating to the second embodiment which is composed in this way, a portion of the light emitted from the LEDs 2 is also incident on the vertical wall section 15a where the installation member 6 is installed, via the opening apertures 61, in addition to the vertical wall section 15b which opposes the vertical wall section 15a where the installation member 6 is installed, of the recess section 12a. A portion of this light propagates through the base member 12 and is irradiated outwards from the gaps 123 between the shaped member 11 and the strip-shaped members 13. Furthermore, the light emitted from the LEDs 2, including the light reflected by the reflector plate 64, is randomly reflected by the inner surfaces of the recess section 12a and is then transmitted through the protective member 66 and irradiated towards the rear side of the handrail main body 1 from the opening hole 111 in the shaped member 11. In particular, in the second embodiment, the LEDs 2 are arranged so as to irradiate light towards the opening hole 111, and a greater amount of light is irradiated towards the rear side of the handrail main body 1 via the opening hole 111. Therefore, when the handrail main body 1 is installed at steps 88, or the like, with the opening hole 111 opening towards the lower side, then the stepping positions of the pedestrian, or the like, are illuminated more brightly.

Here, the handrail main body 1 to which the illumination device relating to the present invention is applied is not limited to a shape which is curved in the front/rear direction along the lengthwise direction as described above, and may also have a shape which is curved in the left/right direction, or a spiral shape, along the lengthwise direction.

Furthermore, the strip-shaped members 13 are not limited to three strips, and may also be two or fewer, or four or more, in number. Moreover, the arrangement of the strip-shaped members 13 is not limited to positions having left/right symmetry as described above.

Furthermore, the material of the strip-shaped members 13 is not limited to metal, and may be an opaque plastic, wood, leather, or the like. Moreover, it is also possible to apply a cosmetic sheet or film, or the like, to the surface of the strip-shaped members 13.

Moreover, the fixing structure of the strip-shaped members 13 is not limited to that described above and it is possible to adopt a structure in which the left and right-hand end portions of the strip-shaped members 13 are fixed by being embedded into the base member 12.

Moreover, it is also possible to arrange a heat transmitting sheet, or the like, between the shaped member 11 and the installation member 6, so as to promote heat transmission between these members.

Furthermore, the concrete shape of the strip-shaped members is not limited to that described above. However, if the strip-shaped members 13 are formed in a plate shape extending in the left/right direction so as to cover the opening section of the shaped member 11 which has a C-shaped cross-section, then since the overall lateral cross-section of the outer shape of the handrail main body 1 is a circular shape or an elliptical shape, it is possible to provide a good gripping sensation for the pedestrian, or the like.

Furthermore, the application of the illumination device relating to the present invention is not limited to a handrail. However, when used in a handrail, the illumination device illuminates the handrail uniformly along the lengthwise direction, and the safety of the pedestrian, or the like, can be guaranteed. Furthermore, the attitude of installation of the handrail main body 1 is not limited to that described above. However, if the handrail main body 1 described above is fixed to the side wall 8, or the like, of the steps 88, in an attitude whereby the opening section of the shaped member 11 faces upwards and the opening hole of the shaped member 11 opens downwards, then it is possible to illuminate the handrail main body 1 without light shining directly into the pedestrian's eyes, as well as being able to illuminate the stepping positions of the pedestrian, or the like.

As described above, the present invention provides an illumination device, comprising: a shaped member which extends in a specific direction, which has an opening section that opens towards a front side of a front/back direction perpendicular to the specific direction, and which has a curved shape that protrudes towards a rear side; a base member which has translucent properties and extends in the specific direction, at least a portion of the base member being accommodated inside the shaped member in a state where a front side portion of the base member is exposed to the outer side of the shaped member via the opening section of the shaped member; a covering member which has light blocking properties, extends in the specific direction and is provided on the front side portion of the base member in a state of covering at least a portion of the front side portion of the base member from the front; and a plurality of light emission members capable of emitting light, wherein the base member has a rear end surface which extends in the specific direction and also has a recess section which is recessed to the front side from the rear end surface, and the light emission members are fixed to an inner side of the recess section so as to be separated from each other in the specific direction.

According to this device, light emitted from a plurality of light emission members illuminates the shaped member via the base member which has translucent properties. The light emission members are fixed to the inner side of the recess section of the base member so as to be separated from each other in the specific direction, and therefore the shaped member is illuminated in substantially uniform fashion along the specific direction.

In the present invention, desirably, an inner surface of the recess section has a vertical wall section extending in the front/rear direction; and the light emission members are fixed to the vertical wall section.

By adopting this composition, it is possible to achieve brighter illumination in a direction perpendicular to the vertical wall section of the recess section, in particular, by the light emitted from the light emission members.

In the present invention, desirably, an inner surface of the recess section has a lateral wall section which extends in a direction perpendicular to the specific direction and the front/rear direction; and the light emission members are fixed to the lateral wall section in an attitude of irradiating light towards the rear side.

By adopting this composition, it is possible to achieve brighter illumination in the rear direction, in particular, by the light emitted from the light emission members.

Furthermore, in the present invention, desirably, the covering member is arranged at a position separated from the shaped member in the front/rear direction.

By adopting this composition, light which is transmitted by the base member is irradiated externally from between the covering member and the shaped member which have light blocking properties and the peripheral area of the illumination device is illuminated more brightly.

Furthermore, in the present invention, desirably, the covering member covers the whole of the front side portion of the base member from the front.

By adopting this composition, it is possible to illuminate the periphery of the illumination device while preventing the light emitted from the light emission members from being irradiated to the front side.

Therefore, for instance, if the illumination device is used as a handrail, and if the shaped member is arranged in an attitude whereby the opening section thereof opens upwards, and if the covering member is arranged in an attitude of covering the whole of an upper side portion of the base member from above, then the handrail is illuminated without shining light directly into the pedestrian's eyes, and therefore the handrail is pleasant for the pedestrian to use.

Furthermore, in the present invention, desirably, the covering member is provided in plurality, and the covering members are arranged substantially in parallel with each other at positions that are mutually separated in the front/rear direction.

By adopting this composition, light transmitted by the base member is irradiated externally from gaps between the covering members which have light blocking properties and the peripheral area of the illumination device is illuminated more brightly.

Furthermore, in the present invention, desirably, a plurality of opening holes which pass in the front/rear direction through a rear side surface of the shaped member are formed in the rear side surface at positions that are mutually separated in the specific direction.

By adopting a composition of this kind, since the light emitted from the light emission members is irradiated to the rear side via the opening holes, then it is possible to provide illumination on the rear side of the illumination device.

Therefore, if the illumination device is used as a handrail and the shaped member is arranged in an attitude whereby the opening holes face downwards, then it is possible to illuminate the stepping positions of a pedestrian.

Here, desirably, the opening holes of the shaped member connect to a space which is surrounded by the recess section.

By adopting a composition of this kind, light of the light emission members arranged in the recess section is irradiated in greater quantity to the rear side via the opening holes, and the rear side of the illumination device can be illuminated more brightly.

Furthermore, desirably, a protective member which closes off each of the opening holes of the shaped member is also provided, and the protective member has translucent properties.

Consequently, it is possible to protect the light emission members, while irradiating the light of the light emission members towards the rear side via the opening holes.

Furthermore, desirably, the present invention further comprises a heat radiating member provided on an inner surface of the recess section and made of metal; and the light emission members are fixed to the heat radiating member.

By adopting this composition, it is possible to disperse the heat emitted from the light emission members as a result of light emission, to the periphery of the light emission members by the heat radiating member, and increase in the temperature of the peripheral area of the light emission members and hence the whole of the illumination device, can be suppressed.

Here, desirably, the heat radiating member is arranged at a position contacting the shaped member.

By adopting this composition, the heat emitted from the light emission members is transmitted to the shaped member via the heat radiating member, and therefore the heat of the light emission members can be dispersed externally by the shaped member, in addition to the heat radiating member. This reliably suppresses increase in the temperature of the peripheral area of the light emission members, and hence the whole illumination device.

The base member is made of plastic, for example.

1. An illumination device, comprising:
a shaped member which extends in a specific direction, which has an opening section that opens towards a front side in a front/rear direction perpendicular to the specific direction, and which has a curved shape that protrudes towards a rear side;
a base member which has translucent properties and extends in the specific direction, at least a portion of the base member being accommodated inside the shaped member in a state where a front side portion of the base member is exposed to the outer side of the shaped member via the opening section of the shaped member;
a covering member which has light blocking properties, extends in the specific direction and is provided on the front side portion of the base member in a state of covering at least a portion of the front side portion of the base member from the front; and
a plurality of light emission members capable of emitting light,
wherein the base member has a rear end surface which extends in the specific direction and also has a recess section which is recessed to the front side from the rear end surface, and
the light emission members are fixed to an inner side of the recess section so as to be separated from each other in the specific direction.

2. The illumination device according to claim 1,
wherein an inner surface of the recess section has a vertical wall section extending in the front/rear direction, and
the light emission members are fixed to the vertical wall section.

3. The illumination device according to claim 1,
wherein an inner surface of the recess section has a lateral wall section which extends in a direction perpendicular to the specific direction and the front/rear direction, and
the light emission members are fixed to the lateral wall section in an attitude of irradiating light towards the rear side.

4. The illumination device according to claim 1, wherein the covering member is arranged at a position separated from the shaped member in the front/rear direction.

5. The illumination device according to claim 4, wherein the covering member covers the whole of the front side portion of the base member from the front.

6. The illumination device according to claim 5, wherein the shaped member is arranged in an attitude whereby the opening section thereof opens upwards and the covering member is arranged in an attitude of covering the whole of an upper side portion of the base member from above, such that the illumination device is used as a handrail.

7. The illumination device according to claim 4,
wherein the covering member is provided in plurality, and
the covering members are arranged substantially in parallel with each other at positions that are mutually separated in the front/rear direction.

8. The illumination device according to claim 1, wherein a plurality of opening holes which pass in the front/rear direction through a rear side surface of the shaped member are formed in the rear side surface at positions that are mutually separated in the specific direction.

9. The illumination device according to claim 8, wherein the shaped member is arranged in an attitude whereby the opening holes face downwards, such that the illumination device is used as a handrail.

10. The illumination device according to claim 8, wherein the opening holes of the shaped member connect to a space which is surrounded by the recess section.

11. The illumination device according to claim 8,
further comprising a protective member which closes off each of the opening holes of the shaped member,
wherein the protective member has translucent properties.

12. The illumination device according to claim 1,
further comprising a heat radiating member provided on an inner surface of the recess section and made of metal,
wherein the light emission members are fixed to the heat radiating member.

13. The illumination device according to claim 12, wherein the heat radiating member is arranged at a position contacting the shaped member.

14. The illumination device according to claim 1, wherein the base member is made of plastic.
